(19) United States
(12) Patent Application Publication
(10) Pub. No.: US 2026/0321214 A1
(43) Pub. Date: Oct. 15, 2026

(54) DISPLAY DEVICE AND ELECTRONIC DEVICE INCLUDING THE SAME

(71) Applicant: SAMSUNG DISPLAY CO., LTD., YONGIN-SI (KR)

(72) Inventors: Byeong Hee WON, Yongin-si (KR); Eun Kyoung NAM, Yongin-si (KR)

(21) Appl. No.: 19/536,438

(22) Filed: Feb. 11, 2026

(30) Foreign Application Priority Data
Apr. 14, 2025 (KR) 10-2025-0047831

(51) Int. Cl. G09G 3/3291; G09G 3/32

(52) U.S. Cl. CPC G09G 3/3291; G09G 3/32; G09G 2310/0275; G09G 2320/0233; G09G 2320/028; G09G 2320/0686; G09G 2354/00

(57) ABSTRACT

A display device includes a tracking camera configured to track a tracked target and a display panel, where the display panel extends in a first direction and includes first and second pixels arranged along the first direction. The display device adjusts first and second data voltages supplied to the respective first and second pixels such that the first apparent luminance and the second apparent luminance, which are respective luminance levels, originating from the first and second pixels at a first location of a tracked target, are substantially the same in a first driving mode, and adjusts third and fourth data voltages supplied to the respective first and second pixels such that the third apparent luminance and the fourth apparent luminance, which are respective luminance levels of the first and second pixels at a second location of the tracked target, are substantially the same in a second driving mode, thereby improving luminance uniformity of the display panel.

### CROSS-REFERENCE TO RELATED APPLICATION

This application claims priority to Korean Patent Application No. 10-2025-0047831 filed on Apr. 14, 2025, in the Korean Intellectual Property Office and all the benefits accruing therefrom under 35 U.S.C. 119, the content of which in its entirety is incorporated by reference herein.

### BACKGROUND

### 1. Technical Field

The present disclosure relates to a display device and an electronic device comprising the same.

### 2. Discussion of the Related Art

Various types of display panels, such as liquid crystal displays (LCDs) and organic light emitting diode (OLED) displays, may be used in a display device. Among those, OLED displays are increasingly used due to their flexibility in shape and form.

One of the key factors that determines image quality, which is important to performance of the display devices, is the uniformity of color reproduction across the display panel. To achieve display uniformity, a flat display panel displays an image on the display panel, measures tristimulus values (XYZ) at multiple sample points across different areas on the panel, and then corrects differences in the measured tristimulus values.

As the size of a display panel increases, a range of the viewing angle, which varies depending on the size of the display panel and viewer's eyes position, also may be widened, accordingly variation of the luminance and the color perceived by the viewer may increase. Consequently, overall luminance on the display panel may appear uneven depending on the viewing angles observed by the viewer.

### SUMMARY

As the size of a display panel increases, a range of the viewing angle, which varies depending on the size of the display panel and viewer's eyes position, also may be widened, accordingly variation of the luminance and the color perceived by the viewer may increase. Consequently, overall luminance on the display panel may appear uneven depending on the viewing angles observed by the viewer, thereby causing non-uniform luminance problem of the display panel.

According to embodiments of the present disclosure, a display device may improve luminance uniformity of a display panel.

In example embodiments, a display device includes a tracking camera configured to track a position of a tracked target, and a display panel extending in a first direction, wherein the display panel includes a first pixel positioned at a first pixel position of the display panel, and configured to exhibit a first luminance in a first driving mode and to exhibit a third luminance in a second driving mode, and a second pixel positioned at a second pixel position spaced apart from the first pixel in the first direction, and configured to exhibit a second luminance in the first driving mode and to exhibit a fourth luminance in the second driving mode, wherein the display device is configured to adjust the first luminance and the second luminance such that a first apparent luminance and a second apparent luminance, which are respective luminance levels, originating from the first and second pixels, at a first location of the tracked target, are substantially equal in the first driving mode, and to adjust the third luminance and the fourth luminance such that a third apparent luminance and a fourth apparent luminance, which are respective luminance levels, originating from the first and second pixels, at a second location of the tracked target, are substantially equal in the second driving mode, where the first driving mode and the second driving mode are determined based on the first and second locations of the tracked target, and the first apparent luminance is different from the second apparent luminance.

In example embodiments, the display device is configured to adjust first and second data voltages supplied to the respective first and second pixels such that the first apparent luminance and the second apparent luminance are substantially the same in the first driving mode, and to adjust third and fourth data voltages supplied to the respective first and second pixels such that the third apparent luminance and the fourth apparent luminance are substantially the same in the second driving mode.

In example embodiments, the distance between the tracked target and the first pixel in the first driving mode is less than a distance between the tracked target and the first pixel in the second driving mode, and a distance between the tracked target and the second pixel in the first driving mode is greater than a distance between the tracked target and the second pixel in the second driving mode.

In example embodiments, the display device is configured to operate in the first driving mode when the distance between the tracked target and the first pixel is less than the distance between the tracked target and the second pixel, and to operate in the second driving mode when the distance between the tracked target and the first pixel is greater than the distance between the tracked target and the second pixel.

In example embodiments, the second apparent luminance is lower than the first apparent luminance.

In example embodiments, the display device is configured to operate either in the first driving mode or in the second driving mode, when the tracking camera has detected the tracked target positioned within a virtual plane that are spaced apart from and overlaps with a surface plane of the display panel in a vertical direction.

In example embodiments, the first pixel is configured to exhibit a fifth luminance and the second pixel is configured to exhibit a sixth luminance in a third driving mode, and the display device is configured to adjust the fifth luminance and the sixth luminance such that a fifth apparent luminance and a sixth apparent luminance, which are luminance levels of the first and second pixels at location of the tracked target, are substantially the same in the third driving mode, the fifth apparent luminance is different from the first apparent luminance, and a distance between the tracked target and a surface plane of the display panel in a vertical direction in the first driving mode is less than a distance between the tracked target and the surface plane of the display panel in the vertical direction in the third driving mode.

In example embodiments, a distance between the tracked target and the surface plane of the display panel in the first driving mode is substantially the same as a distance between the tracked target and the surface plane of the display panel in the second driving mode.

In example embodiments, a distance between the tracked target and the surface plane of the display panel in the first driving mode is less than a distance between the tracked target and the second pixel in the third driving mode.

In example embodiments, in the third driving mode, a distance between the tracked target and the first pixel is less than a distance between the tracked target and the second pixel.

In example embodiments, the first pixel is configured to exhibit a seventh luminance and the second pixel is configured to exhibit an eighth luminance in a fourth driving mode, and the display device is configured to adjust the seventh luminance and the eighth luminance such that a seventh apparent luminance and an eighth apparent luminance, which are respective luminance levels, originating from the first and second pixels at a fourth location of the tracked target, are substantially the same in the fourth driving mode, the seventh apparent luminance is different from the first apparent luminance and the fifth apparent luminance, respectively, and the distance between the tracked target and the surface plane of the display panel in the third driving mode is substantially the same as a distance between the tracked target and the surface plane of the display panel in the fourth driving mode.

In example embodiments, a distance between the tracked target and the first pixel in the third driving mode is less than a distance between the tracked target and the first pixel in the fourth driving mode, and a distance between the tracked target and the second pixel in the third driving mode is greater than a distance between the tracked target and the second pixel in the fourth driving mode.

In example embodiments, a distance between the tracked target and the first pixel in the second driving mode is less than a distance between the tracked target and the first pixel in the fourth driving mode, and a distance between the tracked target and the second pixel in the second driving mode is less than a distance between tracked target and the second pixel in the fourth driving mode.

In example embodiments, an electronic device comprises a processor configured to provide an image signal, a display module configured to receive the image signal from the processor, and to display an image based on the image signal, and a power module supplying a power voltage to the display module, wherein the display module includes a tracking camera configured to track a tracked target, and a display panel extending in a first direction, wherein the display panel includes a first pixel arranged at a first pixel position of the display panel, and configured to exhibit a first luminance in a first driving mode and to exhibit a third luminance in a second driving mode, and a second pixel positioned at a second pixel position spaced apart from the second pixel in the first direction, and configured to exhibit a second luminance in the first driving mode and to exhibit a fourth luminance in the second driving mode, wherein the electronic device is configured to adjust the first luminance and the second luminance such that a first apparent luminance and a second apparent luminance, which are respective luminance levels, originating from the first and second pixels, at a first location of the tracked target, are substantially the same in the first driving mode, and to adjust the third luminance and the fourth luminance such that a third apparent luminance and a fourth apparent luminance, which are respective luminance levels of the first and second pixels, at a second location of the tracked target, are substantially the same in the second driving mode, and the first apparent luminance is different from the second apparent luminance.

In example embodiments, the electronic device is configured to adjust first and second data voltages supplied to the respective first and second pixels such that the first apparent luminance and the second apparent luminance are substantially the same in the first driving mode, and to adjust third and fourth data voltages supplied to the respective first and second pixels such that the third apparent luminance and the fourth apparent luminance are substantially the same in the second driving mode.

In example embodiments, the first pixel is configured to exhibit a fifth luminance and the second pixel is configured to exhibit a sixth luminance in a third driving mode, and the electronic device is configured to adjust the fifth luminance and the sixth luminance such that a fifth apparent luminance and a sixth apparent luminance, which are respective luminance levels, originating from the first and second pixels, at a third location of the tracked target, are substantially the same in the third driving mode, the fifth apparent luminance is different from the first apparent luminance, and a distance between the tracked target and a surface plane of the display panel in a vertical direction in the first driving mode is less than a distance between the tracked target and the surface plane of the display panel in the vertical direction in the third driving mode.

In example embodiments, the first pixel is configured to exhibit a seventh apparent luminance and the second pixel is configured to exhibit an eighth luminance in a fourth driving mode, and the electronic device is configured to adjust the seventh luminance and the eighth luminance such that a seventh apparent luminance and an eighth apparent luminance, which are respective luminance levels, originating from the first and second pixels at a fourth location of the tracked target, are substantially the same in the fourth driving mode, the seventh apparent luminance is different from either the first apparent luminance or the fifth apparent luminance, and the distance between the tracked target and the surface plane of the display panel in the third driving mode is substantially the same as a distance between the tracked target and the surface plane of the display panel in the fourth driving mode.

In example embodiments, a distance between the tracked target and the first pixel in the first driving mode is less than a distance between the tracked target and the first pixel in the third driving mode, and a distance between the tracked target and the first pixel in the second driving mode is less than a distance between the tracked target and the first pixel in the fourth driving mode.

In example embodiments, a distance between the tracked target and the second pixel in the first driving mode is less than a distance between the tracked target and the second pixel in the third driving mode, and a distance between the tracked target and the second pixel in the second driving mode is less than a distance between tracked target and the second pixel in the fourth driving mode.

In example embodiments, a method for operating a display device comprises tracking a position of a tracked target by a tracking camera, and adjusting a first luminance of a first pixel and a second luminance of a second pixel such that a first apparent luminance and a second apparent luminance, which are respective luminance levels of the first and second pixels at a first location of the tracked target, are substantially the same in a first driving mode, and adjusting a third luminance of the first pixel and a fourth luminance of the second pixel such that a third apparent luminance and a fourth apparent luminance, which are respective luminance levels, originating from the first and second pixels, at a second location of the tracked target, are substantially the same in a second driving mode, wherein the first driving mode and the second driving mode are determined based on the first and second locations of the tracked target, and the first apparent luminance is different from the third apparent luminance.

According to the present disclosure, non-uniform luminance problem may be reduced by adjusting luminance levels of the pixels such that their apparent luminance, at location of the tracked target, are substantially the same.

The effects according to the embodiments of the present disclosure are not limited to those mentioned above and more various effects are included in the following description of the present disclosure.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a perspective view illustrating a display device according to one embodiment of the present disclosure;

FIG. 2 is a block diagram schematically illustrating a display device according to one embodiment of the present disclosure;

FIG. 3 is a graph illustrating relative luminance values at various emission angles from a pixel according to one embodiment of the present disclosure, in which the luminance distribution follows a Lambertian distribution;

FIGS. 4, 5 and 6 are graphs illustrating relative luminance values at various emission angles from a pixel according to one embodiment of the present disclosure, in which the luminance distribution follows a Gaussian distribution;

FIG. 7 is a graph comparing relative luminance values of light emitted from a subpixel according to one embodiment of the present disclosure;

FIG. 8 is a view illustrating a positional relationship between a display panel and a tracked target according to one embodiment of the present disclosure;

FIG. 9 is a view illustrating a display panel operating in a first driving mode according to one embodiment of the present disclosure;

FIG. 10 is a view illustrating a display panel operating in a first threshold driving mode according to one embodiment of the present disclosure;

FIG. 11 is a view illustrating a display panel operating in a second driving mode according to one embodiment of the present disclosure;

FIG. 12 is a view illustrating a display panel operating in a fifth driving mode according to one embodiment of the present disclosure;

FIGS. 13, 14, 15 and 16 are graphs comparing relative luminance values of the display panel operating in respective driving modes;

FIGS. 17 and 18 are views illustrating a display panel operating in a third driving mode according to one embodiment of the present disclosure;

FIG. 19 is a view illustrating a display panel operating in a second threshold driving mode according to one embodiment of the present disclosure;

FIG. 20 is a graph comparing relative luminance values of light emitted from a subpixel according to one embodiment of the present disclosure;

FIG. 21 is a block diagram illustrating an electronic device according to one embodiment of the present disclosure; and

FIG. 22 illustrates schematic views of electronic devices according to embodiments of the present disclosure.

### DETAILED DESCRIPTION OF THE DISCLOSURE

The advantages and features of the embodiments disclosed herein, as well as methods for achieving them, will become apparent with reference to the detailed descriptions and accompanying drawings. However, the inventive concept described in the present disclosure is not limited to the disclosed embodiments. Rather, it may be implemented in many different forms. These embodiments are provided solely to make the disclosure complete and to fully inform one of ordinary skill in the art to which the invention pertains. The scope of invention according to the present disclosure is defined by the claims.

References to an element or layer being “on” another element or layer include both cases where the layer or element is directly positioned on top and where one or more layers or elements are interposed between them. Throughout this specification, like reference numerals refer to like components. The shapes, sizes, proportions, angles, quantities, and other attributes shown in the drawings are provided for illustrative purpose only and are not intended to limit the scope of the embodiments disclosed herein. The term “substantially” is used to describe allowable variations of “luminance values” or “apparent luminance values” from a target value, in terms of a tolerance range of the target value as expected by one skilled in the art.

Although the terms such as “first” and “second” are used to describe various components, these terms are not intended to limit the components. For example, a “first” component may also be referred to as a “second” component within the scope of technical concept of the present invention.

Furthermore, the features of the various embodiments disclosed herein may be combined or used in conjunction with one other, either partially or entirely. These features may be technically integrated and operated in various ways, and each embodiment may be implemented independently or in combination with other elements.

Specific embodiments will be described below with reference to the accompanying drawings. Configurations that perform substantially the same functions across different embodiments are given the same reference numerals, and repeated descriptions are omitted.

A display device includes a tracking camera configured to track a tracked target and a display panel, where the display panel extends in a first direction and includes first and second pixels arranged along the first direction. The display device adjusts first and second data voltages supplied to the respective first and second pixels such that a first apparent luminance and a second apparent luminance, which are respective luminance levels, originating from the first and second pixels, at a first location of the tracked target, are substantially equal in a first driving mode, and adjusts third and fourth data voltages supplied to the respective first and second pixels such that a third apparent luminance and a fourth apparent luminance, which are respective luminance levels, originating from the first and second pixels at a second location of the tracked target, are substantially equal in a second driving mode, thereby improving luminance uniformity of the display panel.

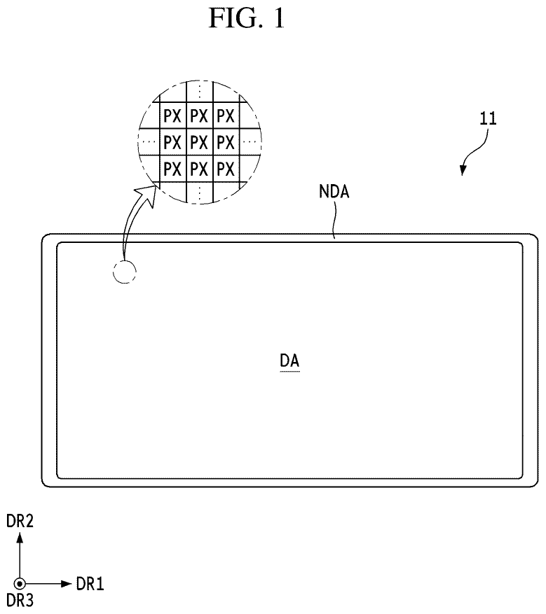

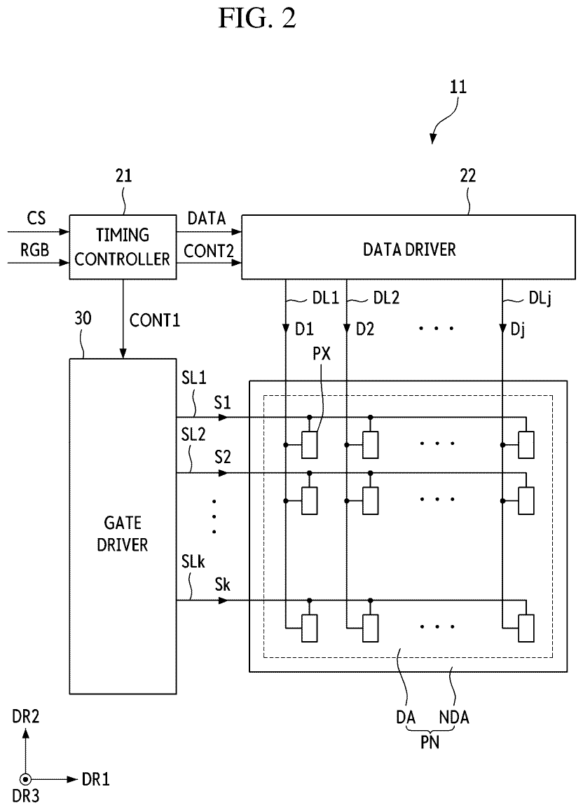

FIG. 1 is a perspective view illustrating a display device according to one embodiment of the present disclosure. FIG. 2 is a block diagram schematically illustrating a display device according to one embodiment of the present disclosure.

Referring to FIGS. 1 and 2, a display device 11 may display moving images and still images. The display device 11 may encompass any electronic device equipped with a display screen. For example, the display device 11 may include a television, a laptop computer, a monitor, an advertising board, Internet of Things, a mobile phone, a smart phone, a tablet personal computer (PC), an electronic watch, a smart watch, a watch phone, a head mounted display, a mobile communication terminal, an electronic diary, an electronic book, a portable multimedia player (PMP), a navigator, a game machine, a digital camera, a camcorder and any other device that provide a display screen.

The display device 11 includes a display panel that provides a display screen. For example, the display panel may include an LED display panel, an organic light emitting display panel, a quantum dot light emitting display panel, a plasma display panel, and a field emission display panel. The following description is based on an LED display panel as an example of the display panel. However, the present disclosure is not limited to this example, and other types of display panels may be applied, provided that they fall within the scope of the same technical spirits.

Various modifications may be made to the shape of the display device 11. For example, the display device 11 may have a shape of a wide rectangle, a tall rectangle, a square, a rectangle with round corners (vertexes), other polygonal shapes, or a circle. A shape of a display area DA of the display device 11 may also correspond to an overall shape of the display device 11. In the drawings, a rectangular display device 11 with a display area DA of a longer horizontal dimension is illustrated.

The display device 11 may include a display area DA and a non-display area NDA. The display area DA may be an area in which an image is displayed, and the non-display area NDA may be an area in which the image is not displayed. The display area DA may be referred to as an active area, and the non-display area NDA may be referred to as a non-active area.

The display area DA may be generally located at the center of the display device 11. The display area DA may include a plurality of pixels PX. The plurality of pixels PX may be arranged in a matrix pattern. A shape of each pixel PX may be a rectangular or square on a plane, but is not limited thereto, and may be a rhombus, with each side inclined relative to a first direction DR1.

The display device 11 according to one embodiment includes a display panel PN, integrated driving circuits 21 and 22, and a scan driver 30. The integrated driving circuits 21 and 22 may include a timing controller 21 and a data driver 22.

The display panel PN may include a display area DA in which pixels PX are formed to display an image and a non-display area NDA that is a peripheral area of the display area DA. When the display panel PN includes a curved portion, the display area DA may be arranged on the curved portion. In this case, the image displayed by the display panel PN may also appear on the curved portion.

In addition to the pixels PX, scan lines SL1 to SLk (k is an integer equal to or greater than two), data lines DL1 to DLj (j is an integer equal to or greater than two), and power lines may be arranged in the display area DA. The scan lines SL may be formed in parallel in the first direction DR1, and the data lines DL may be formed in parallel in a second direction DR2 crossing the first direction DR1. Each of the pixels PX may be connected to at least one of the scan lines SL and to one of the data lines DL.

Each of the pixels may include a driving transistor, at least one switching transistor, a light emitting element, and a capacitor. Since the switching transistor is turned on when a scan signal is applied through the scan line SL, a data voltage may be applied to a gate electrode of the driving transistor through the data line DL. The driving transistor may supply a driving current, which is proportional to the data voltage applied to the gate electrode, to the light emitting element, thereby enabling the light emitting element to emit light. The driving transistor and at least one switching transistor may be a thin film transistor. The light emitting element may emit light in proportion to the driving current of the driving transistor, and may be implemented as an organic light emitting diode including a first electrode, an organic light emitting layer, and a second electrode. The capacitor may be configured to stably maintain the data voltage applied to the gate electrode of the driving transistor.

The non-display area NDA may be an area outside the display area DA of the display panel PN. The scan driver 30, which applies scan signals to the scan lines SL, and the integrated driving circuits 21 and 22 may be arranged within the non-display area NDA.

The integrated driving circuits 21 and 22 may include a timing controller 21 and a data driver 22, and generate signals and voltages for driving the display panel PN.

The timing controller 21 receives digital video data DATA and timing signals from a host system. The timing signals may include a vertical sync signal, a horizontal sync signal, a data enable signal, and a dot clock. The host system may be an application processor of a smartphone or a tablet PC, a system-on-chip of a monitor or TV, and the like.

The timing controller 21 receives control signal CS for controlling operation timings of the data driver 22 and the scan driver 30. The timing controller 21 may generate a source control signal CONT2 for controlling the operation timing of the data driver 22 and a scan control signal CONT1 for controlling the operation timing of the scan driver 30 based on the control signal CS.

The data driver 22 receives the digital video data DATA and the source control signal CONT2 from the timing controller 21. The data driver 22 converts the digital video data DATA into analog data voltages in response to the source control signal CONT2 and supplies the converted analog data voltages to the data lines DL1 to DLj of the display panel PN.

The integrated driving circuits 21 and 22 may be arranged in the non-display area NDA located on one side of the display panel PN. The integrated driving circuits 21 and 22 may be implemented as integrated circuits (IC) and mounted on the display panel PN in a manner such as a chip on glass (COG), chip on plastic (COP), or ultrasonic bonding, but the present disclosure is not limited thereto. For example, the integrated driving circuits 21 and 22 may be mounted on a circuit board instead of the display panel PN.

Although FIG. 2 illustrates that the integrated driving circuits 21 and 22 include a data driver 22 and a timing controller 21, the present disclosure is not limited thereto. The data driver 22 and the timing controller 21 may be implemented as separate integrated circuits rather than a single integrated circuit. In such configurations, the data driver 22 may be mounted on the display panel PN in a manner such as a chip on glass (COG), chip on plastic (COP), or ultrasonic bonding, and the timing controller 21 may be separately mounted on the circuit board.

The scan driver 30 (i.e., gate driver) receives the scan control signal CONT1 from the timing controller 21. The scan driver 30 generates the scan signals in accordance with the scan control signal CONT1 and supplies the generated scan signals to the scan lines SL1 to SLk of the display panel PN. The scan driver 30 may include a plurality of transistors and may be implemented on a circuit board attached on the non-display area NDA of the display panel PN. Alternatively, the scan driver 30 may be separately implemented as an integrated circuit, and may be mounted on the opposite side of the display panel PN using a gate flexible film.

Although not shown in the drawing, the circuit board may be attached onto pads provided at one edge area of the display panel PN using an anisotropic conductive film, and lead lines of the circuit board may be electrically connected to the pads. The circuit board may be a flexible printed circuit board, a printed circuit board, or a flexible film such as a chip on film. The circuit board may be bent toward the lower portion of the display panel PN. In this configuration, one side portion of the circuit board may be attached to one edge of the display panel PN, while the other side portion of the circuit board may be extended beneath the display panel PN and connected to a system board on which the host system is mounted.

The power supply circuit may generate voltages required to drive the display panel PN from a main power source applied from the system board and supply the generated voltages to the display panel PN. For example, the power supply circuit may generate first and second power voltages for driving the light emitting elements EL of the display panel PN from the main power source, and supply the first and second power voltages to first and second voltage lines of the display panel PN, respectively. In addition, the power supply circuit may generate and supply driving voltages for driving the integrated driving circuits 21 and 22 and the scan driver 30 from the main power source.

The power supply circuit may be formed as an integrated circuit and mounted on the circuit board, but is not limited thereto. For example, the power supply circuit may be integrated into the integrated driving circuits 21 and 22.

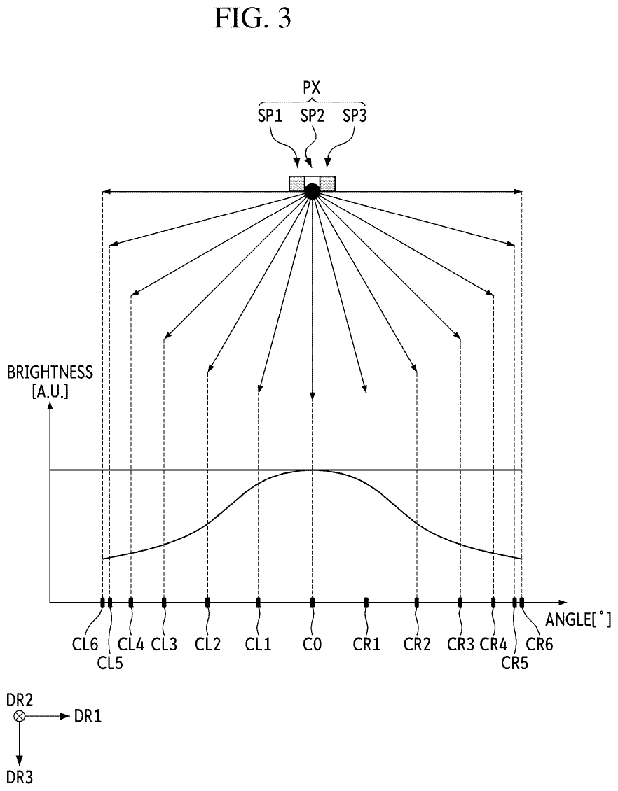

FIG. 3 is a graph illustrating relative luminance values at various emission angles from a pixel according to one embodiment of the present disclosure, in which the luminance distribution follows a Lambertian distribution.

Referring to FIG. 3, the pixel PX according to one embodiment may include a plurality of subpixels SP1, SP2 and SP3. The plurality of subpixels SP1, SP2 and SP3 include a first subpixel SP1, a second subpixel SP2, and a third subpixel SP3. The first subpixel SP1 may emit a first color, the second subpixel SP2 may emit a second color, and the third subpixel SP3 may emit a third color. Each of the first color, the second color, and the third color may be independently selected from a group consisting of red, green and blue, and may be different from one another. For example, the first subpixel SP1 may emit red, the second subpixel SP2 may emit green, and the third subpixel SP3 may emit blue, but the embodiments of the present disclosure are not limited thereto. The plurality of subpixels SP1, SP2 and SP3 may further include a fourth subpixel for emitting a fourth color. In one embodiment, the fourth subpixel may be white.

In one embodiment, light emitted from the second subpixel SP2 may follow a Lambertian distribution. When light emission follows the Lambertian distribution characteristics, the surface of the second subpixel SP2 may appear to maintain uniform brightness or luminance regardless of viewing angles.

Referring to the graph, when the second subpixel SP2 is viewed from a reference angle C0, the second subpixel SP2 may emit light at a specific luminance. In addition to the reference angle C0, the viewing angle with respect to the second subpixel SP2 may include a first left angle CL1, a second left angle CL2, a third left angle CL3, a fourth left angle CL4, a fifth left angle CL5, a sixth left angle CL6, a first right angle CR1, a second right angle CR2, a third right angle CR3, a fourth right angle CR4, a fifth right angle CR5, a sixth right angle CR6, etc. Since the viewing angle at which the second subpixel SP2 is viewed may be continuous, the angle is not limited to those illustrated. For convenience of description, the illustrated viewing angle may be segmented into 15° intervals, derived by dividing a right angle (i.e., 90°) into six equal parts.

When light emission follows the Lambertian distribution, the second subpixel SP2 exhibits a surface luminance that appears consistent across all viewing angles. As a result, the relative luminance may be uniform regardless of viewing angles as shown in the relative luminance value graph.

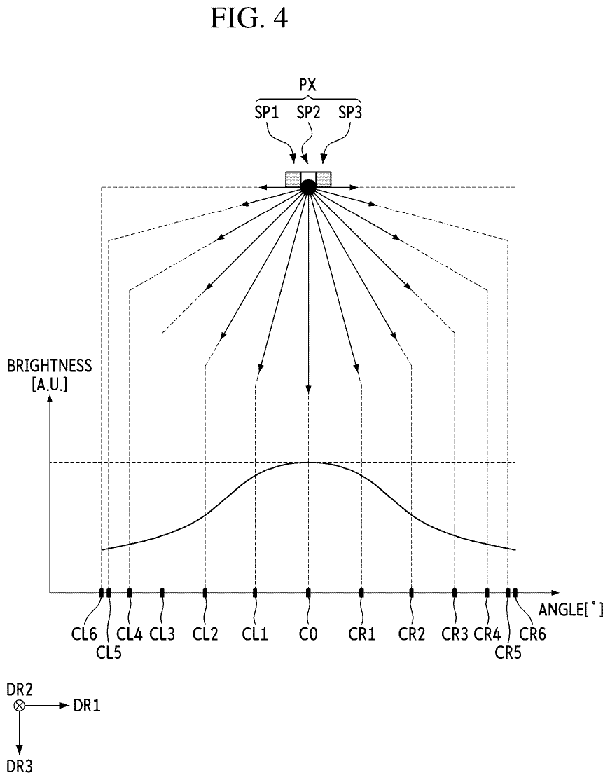

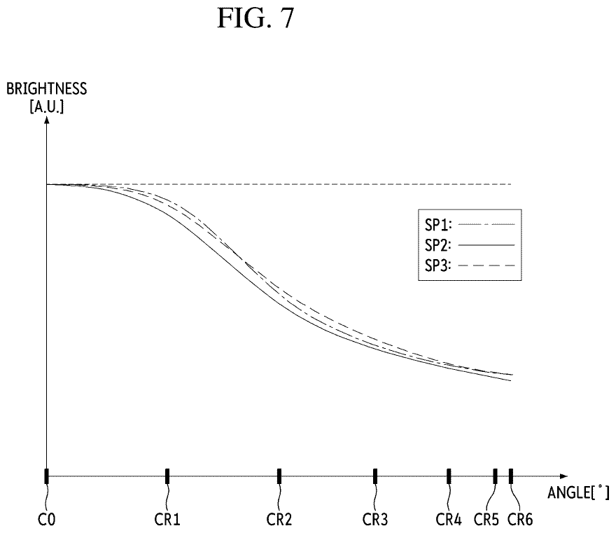

FIGS. 4, 5 and 6 are graphs illustrating relative luminance values at various emission angles from a pixel according to one embodiment of the present disclosure, in which the luminance distribution follows a Gaussian distribution. FIG. 7 is a graph comparing relative luminance values of light emitted from a subpixel according to one embodiment of the present disclosure.

Referring to FIG. 4, the light emitted from the second subpixel SP2 may not follow the Lambertian distribution, but instead may follow a Gaussian distribution. When the light emitted from the second subpixel SP2 follows the Gaussian distribution, the second subpixel SP2 may have a surface that appears to exhibit different luminance depending on a viewing angle. When observed at the reference angle C0, the second subpixel SP2 may exhibit maximum luminance. At viewing angles other than the reference angle C0, the luminance of the second subpixel SP2 may be lower than the maximum luminance. Because the same data voltage is supplied to the second subpixel SP2, the second subpixel SP2 may emit light with the same luminance. However, luminance of the second subpixel SP2 may vary depending on the viewing angles as described above. Therefore, even when the second subpixel SP2 emits light in a uniform luminance, a luminance perceived by a viewer may vary depending on the viewing angles. The luminance perceived by a viewer may be referred to as an apparent luminance.

The Gaussian distribution may be substantially similar to the normal distribution curve as they describe the same statistical behavior. As the second subpixel SP2 is viewed from an angle that significantly deviates from the reference angle C0, the observed luminance (i.e., apparent luminance) may decrease accordingly. Because the observation angle varies continuously, the observed luminance may also exhibit a continuous variation across the viewing angles.

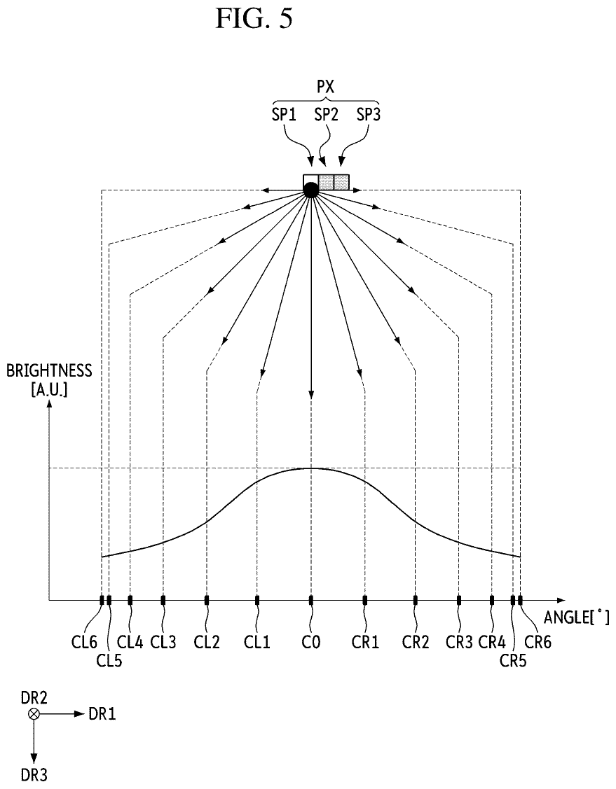

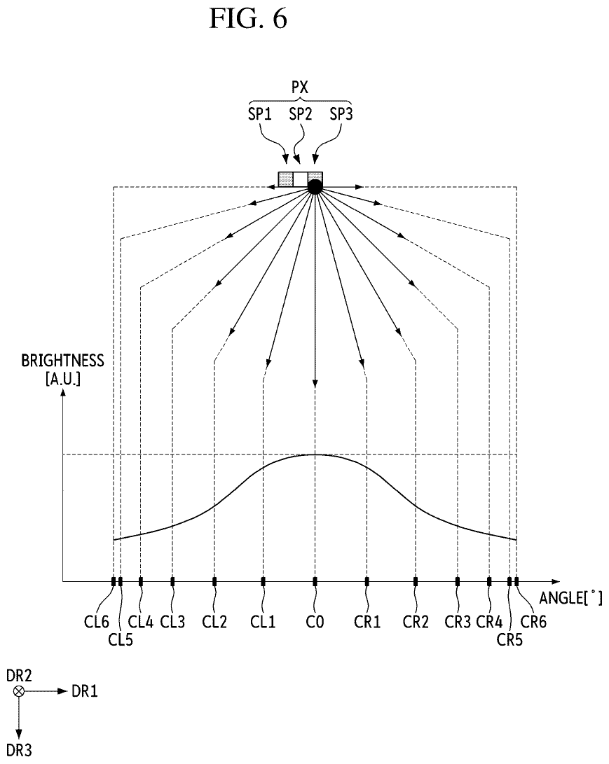

Referring to FIGS. 5 and 6, unlike the light emitted from the second subpixel SP2, the light emitted from the first subpixel SP1 and the third subpixel SP3 may not follow the Lambertian distribution.

Referring to FIG. 7, the relative luminance value graphs corresponding to viewing angles for the first subpixel SP1, the second subpixel SP2, and the third subpixel SP3 may also be different from one another. The pixel PX may include a first subpixel SP1, a second subpixel SP2, and a third subpixel SP3, and may emit red, green, and blue lights respectively. Consequently, the light emitted from the pixel PX may be white. The luminance of the white color may vary depending on the luminance of the first subpixel SP1, the luminance of the second subpixel SP2, and the luminance of the third subpixel SP3. In addition, the luminance of the first subpixel SP1, the luminance of the second subpixel SP2, and the luminance of the third subpixel SP3 may appear different even at the same viewing angle.

Specifically, even among subpixels SP1, SP2 and SP3 of a pixel PX, each luminance value of the subpixels SP1, SP2 and SP3 may be measured differently depending on the viewing angles. For example, each luminance value of the subpixels SP1, SP2 and SP3 measured at a specific angle may be different.

The present disclosure provides a solution to address the problem that the luminance observed by a user may not be uniform across the display panel PN, where the display panel PN includes subpixels SP1, SP2 and SP3 that emit light with non-Lambertian distribution characteristics.

The relative luminance value graph illustrates luminance of the light emitted from the second subpixel SP2. Light emitted from numerous subpixels SP1, SP2 and SP3, which emit light at equal luminance, is collected to form an image on the display panel PN. When the display panel PN is viewed, the brightness of light emitted by the subpixels SP1, SP2 and SP3, which are arranged at various locations across the display panel PN, may not be uniform depending on the observation angle of the display panel PN. The luminance graph of the subpixels SP1, SP2 and SP3 according to the observation angle of the display panel PN may correspond to the relative luminance value graph according to angles at which respective subpixels SP1, SP2 and SP3 are observed. Accordingly, the luminance graph of the subpixels SP1, SP2 and SP3 according to the observation angle of the display panel PN may follow the Gaussian distribution rather than the Lambertian distribution.

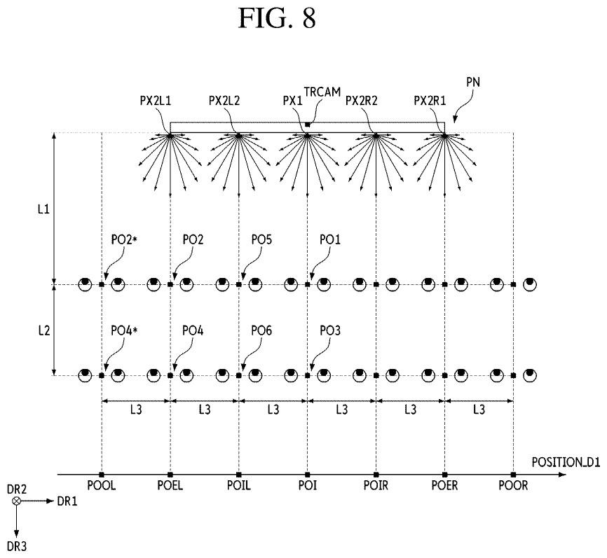

FIG. 8 is a view illustrating a positional relationship between a display panel and a tracked target according to one embodiment of the present disclosure.

Referring to FIG. 8, the display device may include a tracking camera TRCAM for tracking a tracked target. The display device may include a display panel PN that is configured to extend in the first direction DR1. The tracking camera TRCAM may be integrated into the display panel PN, but the embodiment of the present disclosure is not limited thereto.

The display panel PN may include a first pixel PX1 arranged at a central portion of the display panel PN. In addition, the display panel PN may include a second pixel PX2 spaced apart from the first pixel PX1 in the first direction DR1. The second pixel PX2 may include second pixels PX2L1, PX2L2, PX2R1 and PX2R2 arranged at either left side of the display panel PN or right side of the display panel PN. Specifically, among the second pixels PX2L1, PX2L2, PX2R1 and PX2R2, a first portion of the second pixels (e.g., PX2L1 and PX2L2) may be arranged at the left side of the display panel PN and a second portion of the second pixels (e.g., PX2R1 and PX2R2) may be arranged at the right side of the display panel PN. Among the first portion of the pixels (e.g., PX2L1 and PX2L2) arranged at the left side, the second pixel PX2L1 may be arranged relatively farther from the first pixel PX1 than the second pixel PX2L2. Likewise, among the second portion of the pixels PX2R1 and PX2R2 arranged at the right side, the second pixel PX2R1 may be arranged relatively farther from the first pixel PX1 than the second pixel PX2R2.

In the display device according to one embodiment, the tracked target may be positioned at multiple locations, and the tracking camera TRCAM may change a driving mode of the display device by tracking the position of the tracked target. The tracked target is an object to be tracked by the tracking camera TRCAM, and in one embodiment, the tracked target may be a point between both eyes of a user, or a single eye of a user.

For example, the tracked target may be positioned at a first position PO1, and the tracking camera TRCAM may detect the tracked target at the first position PO1, thereby enabling the display device to operate in a first driving mode.

Alternatively, the tracked target may be positioned at a second position PO2, and the tracking camera TRCAM may detect the tracked target at the second position PO2, thereby enabling the display device to operate in a second driving mode. Alternatively, the tracked target may be located at a (2*)th position PO2*, and the tracking camera TRCAM may detect the tracked target at the (2*)th position PO2*, thereby enabling the display device to operate in a first threshold driving mode. The (2*)th position PO2*, being adjacent to the second position PO2, may be a position located outside a virtual plane that is spaced apart from and vertically overlapped with the display panel.

Alternatively, the tracked target may be positioned at a third position PO3, and the tracking camera TRCAM may detect the tracked target at the third position PO3, thereby enabling the display device to operate in a third driving mode.

Alternatively, the tracked target may be positioned at a fourth position PO4, and the tracking camera TRCAM may detect the tracked target at the fourth position PO4, thereby enabling the display device to operate in a fourth driving mode. Alternatively, the tracked target may be located at a (4*)th position PO4*, and the tracking camera TRCAM may detect the tracked target at the (4*)th position PO4*, thereby enabling the display device to operate in a (4*)th driving mode. The (4*)th position PO4*, being adjacent to the fourth position PO4, may be a position located outside a virtual plane that is spaced apart from and vertically overlapped with the display panel. The (4*)th position PO4* may be located farther from the display panel in the third direction (i.e., vertical direction) than the (2*)th position PO2*

Alternatively, the tracked target may be positioned at a fifth position PO5, and the tracking camera TRCAM may detect the tracked target at the fifth position PO5, thereby enabling the display device to operate in a fifth driving mode.

Alternatively, the tracked target may be positioned at a sixth position PO6, and the tracking camera TRCAM may detect the tracked target at the sixth position PO6, thereby enabling the display device to operate in a sixth driving mode.

For convenience of description, positions of the tracked target that determine the driving modes are presumed to be located at grid points. However, the position of the tracked target may not be limited to the specific grid points, but may be located at any positions between the grid points. In the present disclosure, it is illustrated that positions of the tracked target are located at the grid points for clear differentiation between driving modes based on the positions of the tracked target. In one embodiment, a surface plane of the display panel PN may extend along the first direction DR1 and the second direction DR2. The first position PO1, the second position PO2, the (2*)th position PO2*, and the fifth position PO5 may each be spaced apart from the surface plane of the display panel PN by a first distance L1 in the vertical direction. The third position PO3, the fourth position PO4, the (4*)th position PO4*, and the sixth position PO6 may each be spaced apart from the surface plane of the display panel PN by a distance equal to the sum of the first distance L1 and a second distance L2.

Accordingly, the distance between the first position PO1 and the plane may be less than the distance between the third position PO3 and the plane. Likewise, the distance between the second position PO2 and the plane may be less than the distance between the fourth position PO4 and the plane.

A plurality of pixel positions may be defined along the first direction DR1 on the surface plane of the display panel PN along the first direction. A fourth pixel position POI may be defined as a location of the first pixel PX1 and may be aligned with corresponding viewpoints (e.g., the first position PO1 and the third position PO3). A third pixel position POIL may a location of the second pixel PX2L2 and may be aligned with corresponding viewpoints (e.g., the fifth position PO5 and the sixth position PO6). A second pixel position POEL may be a location of the second pixel PX2L1 and may be aligned with corresponding viewpoints (e.g., the second position PO2 and the fourth position PO4). A first virtual pixel position POOL may be aligned with corresponding viewpoints, such as the (2*)th position PO2* and the (4*)th position PO4*. A sixth pixel position POER, and a fifth pixel position POIR may be locations of the second pixels PX2R2 and PX2R1 and may be aligned with corresponding viewpoints in a symmetrical manner relative to the fourth pixel position POI. A seventh virtual pixel position POOR may be aligned with corresponding viewpoint in a symmetrical manner relative to the first pixel position POI. Intervals between the respective pixel positions may be assumed equal to each other as a third distance L3. Accordingly, the interval between the first position PO1 and the fifth position PO5 in the first direction DR1 may be the third distance L3. Likewise, the interval between the fifth position PO5 and the second position PO2 in the first direction DR1 may also be the third distance L3.

For convenience of description, it is assumed that all intervals in the first direction DR1 are the same as the third distance L3, but the embodiments of the present disclosure are not limited thereto.

The first position PO1, the second position PO2, the fifth position PO5, the third position PO3, the fourth position PO4, and the sixth position PO6 may be located within virtual planes that are spaced apart from and overlaps the display panel PN in a third direction DR3 (i.e., vertical direction relative to the display panel PN). For example, these positions may be aligned with the corresponding first and second pixel positions including the second position POEL, the third position POIL, the fourth position POI, the fifth position POIR, and the sixth position POER. The (2*)th position PO2* and the (4*)th position PO4* may be located at positions outside the display panel PN in the third direction DR3. For example, these positions may be aligned with the first virtual pixel position POOL and the seventh virtual pixel position POOR respectively, in which the (2*)th position PO2* and the (4*)th position PO4* may not be positions that are aligned with the display panel PN in the third direction DR3.

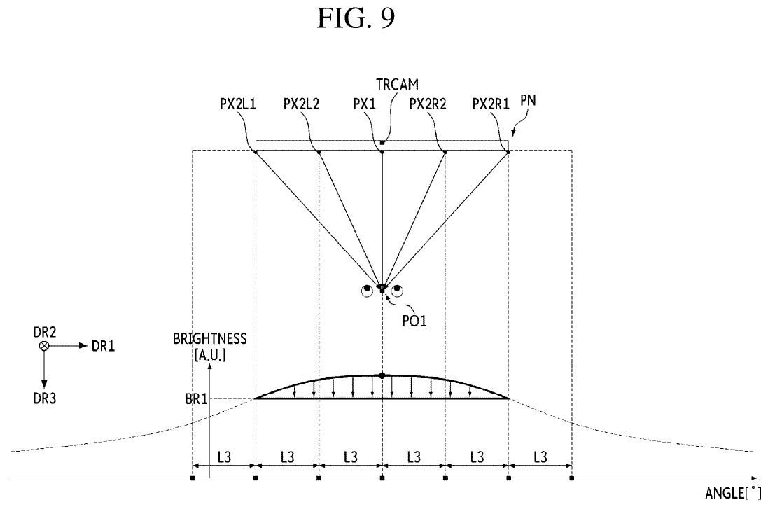

FIG. 9 is a view illustrating a display panel operating in a first driving mode according to one embodiment of the present disclosure.

Referring to FIG. 9, the tracked target may be positioned at the first position PO1. The tracking camera TRCAM may detect the tracked target at the first position PO1, thereby enabling the display device to operate in the first driving mode.

A relative luminance value graph based on a viewing angle observed from the tracked target positioned at the first position PO1 is shown. Since light emitted from the first pixel PX1 and the second pixels PX2L1, PX2L2, PX2R1 and PX2R2 follows a Gaussian distribution, a relative luminance value perceived by the tracked target positioned at the first position PO1 may follow the Gaussian distribution.

In a related art, although all pixels may emit light at the same luminance, luminance perceived by the tracked target positioned at the first position PO1, in accordance with the Gaussian distribution, may be different depending on the position of the pixel. The relative luminance value perceived by the tracked target may be referred to as apparent luminance. Specifically, a first apparent luminance and a second apparent luminance may be respective luminance levels of the first and second pixels at a first location of the tracked target, and a third apparent luminance and a fourth apparent luminance may be respective luminance levels, originating from the first and second pixels, at a second location of the tracked target. Accordingly, the indication that the apparent luminance is substantially equal may mean that the relative luminance value perceived by the tracked target is substantially equal, but the embodiment of the present disclosure is not limited thereto. For example, the apparent luminance values of light emitted by the plurality of pixels PX1 and PX2 arranged on the display panel PN may be all regarded as the same regardless of the positions of the plurality of pixels PX1 and PX2. For example, when the size of the display panel PN is small, the apparent luminance value difference between the pixels PX1 and PX2 according to the viewing angle is also small, and the apparent luminance values perceived by the tracked target may be substantially the same.

The display device is configured to operate in a first driving mode, when a distance between the tracked target and the first pixel PX1 is less than a distance between the tracked target and the second pixels PX2L1, PX2L2, PX2R1 and PX2R2. The first pixel PX1 may be arranged at the central portion of the display panel PN, and the tracked target positioned at the first position PO1 may be aligned with a virtual straight line extended from the central portion of the display panel PN along the third direction DR3. In this case, an angle formed by the tracked target and the first pixel PX1 may be 0°, and the tracked target may perceive the highest luminance among light emitted from the first pixel PX1. When the second pixel is observed at the first position PO1, according to the Gaussian distribution, the luminance perceived by the tracked target positioned at the first position PO1 decreases as the second pixel is located farther from the central portion of the display panel PN, or farther from the first pixel PX1. In other words, the apparent luminance perceived by the tracked target positioned at the first position PO1 decreases as the second pixel is located farther from the central portion of the display panel PN. Accordingly, the apparent luminance perceived by the tracked target positioned at the first position PO1 may vary depending on the position of the second pixel on the display panel PN, thereby causing non-uniform luminance.

In one embodiment, in order to address the non-uniform luminance, luminance of respective pixels may be reduced to match the smallest luminance value perceived by the tracked target positioned at the first position PO1 (i.e., apparent luminance value at the first position PO1). For example, since the second pixel PX2L1 is arranged at the leftmost side of the display panel PN and the second pixel PX2R1 arranged at the rightmost side, the light emitted from those second pixels may be perceived as the lowest luminance by the tracked target positioned at the first position PO1. Accordingly, the display device may reduce the luminance of the first pixel PX1 to match the lowest apparent luminance at the first position PO1. Specifically, when the luminance of light emitted by those second pixels exhibits a first apparent luminance BR1, the display device operating in the first driving mode may reduce the luminance of the respective pixels to match the apparent luminance perceived at the first position PO1 to the first apparent luminance BR1 to improve luminance uniformity.

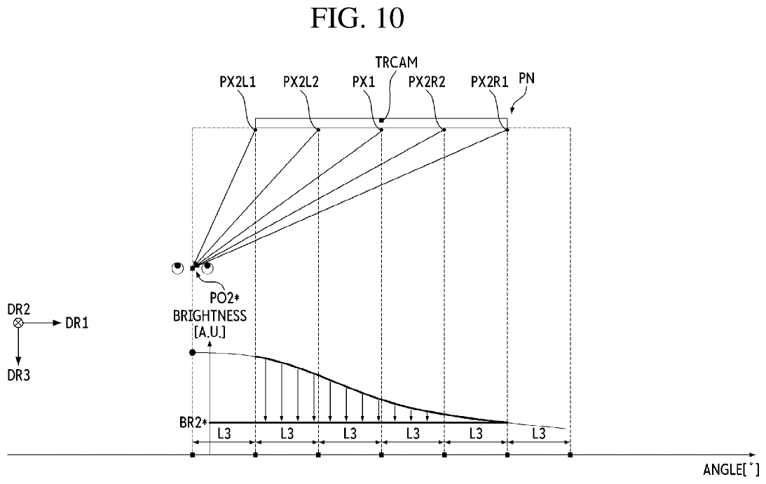

FIG. 10 is a view illustrating a display panel operating in a first threshold driving mode according to one embodiment of the present disclosure.

Referring to FIG. 10, the tracked target may be positioned at the (2*)th position PO2*. The tracking camera TRCAM may recognize the tracked target positioned at the (2*)th position PO2*, thereby enabling the display device to operate in the first threshold driving mode.

A relative luminance value graph, according to a viewing angle observed from the tracked target positioned at the (2*)th position PO2*, is shown. Since light emitted from the first pixel PX1 and the second pixels PX2L1, PX2L2, PX2R1 and PX2R2 follows the Gaussian distribution, the relative luminance value perceived by the tracked target positioned at the (2*)th position PO2* may follow the Gaussian distribution.

In a related art, although all pixels may emit light at the same luminance, luminance perceived by the tracked target positioned at the (2*)th position PO2*, in accordance with the Gaussian distribution, may be different depending on the position of the pixel. The relative luminance value perceived by the tracked target may be referred to as apparent luminance. Accordingly, the indication that the apparent luminance is substantially the same may mean that the relative luminance value perceived by the tracked target may be the same, but the embodiment of the present disclosure is not limited thereto. In certain cases, the apparent luminance values of light emitted by the plurality of pixels PX1 and PX2 arranged on the display panel PN may be all regarded as the same regardless of the positions of the plurality of pixels PX1 and PX2. For example, when the size of the display panel PN is small, the apparent luminance value difference between the pixels PX1 and PX2 according to the viewing angle is also small, and the apparent luminance values perceived by the tracked target may be substantially the same.

The display device is configured to operate in the first threshold driving mode, when a distance between the tracked target and the first pixel PX1 is greater than a distance between the tracked target and the second pixels PX2L1 and PX2L2. In the first threshold driving mode, the distance between the tracked target and the first pixel PX1 may be less than a distance between the tracked target and the second pixels PX2R2 and PX2R1. Though any of the second pixel does not exist at a position corresponding to the (2*)th position PO2*, when it is assumed that a (2*)th pixel is positioned at the (2*)th position PO2*, an angle formed by the tracked target and the (2*)th pixel may be 0°, and the tracked target positioned at the (2*)th position PO2*may perceive the highest luminance from the (2*)th pixel. When the second pixel is observed at the (2*)th position PO2*, according to the Gaussian distribution, the luminance perceived by the tracked target positioned at the (2*)th position PO2* decreases as the pixel is located farther from the (2*)th pixel. In other words, the apparent luminance perceived by the tracked target positioned at the (2*)th position PO2* decreases as the pixel is located farther from the (2*)th pixel. Accordingly, the apparent luminance perceived by the tracked target positioned at the (2*)th position PO2* may vary depending on the position of the pixel on the display panel PN, thereby causing non-uniform luminance.

In one embodiment, in order to address the non-uniform luminance, luminance of respective pixels may be reduced to match the smallest luminance value perceived by the tracked target positioned at the (2*)th position PO2*. For example, since the second pixel PX2R1 is arranged at the rightmost side of the display panel PN, in accordance with the Gaussian distribution, the light emitted from the second pixel PX2R1 may be perceived as the lowest luminance by the tracked target positioned at the (2*)th position PO2*. Accordingly, the display device may reduce the luminance of the first and second pixels to match the lowest apparent luminance at the (2*)th position PO2*. Specifically, when the luminance of light emitted by the second pixel PX2R1 exhibits a (2*)th apparent luminance BR2*, the display device operating in the first threshold driving mode may reduce the luminance of the respective pixels to match the apparent luminance of the pixels perceived at the (2*)th position PO2* to the (2*)th apparent luminance BR2* to improve luminance uniformity.

Since the second pixel PX2L1 positioned at the leftmost side has the highest apparent luminance value perceived by the tracked target positioned at the second position PO2, a data voltage supplied may be lowered to reduce the apparent luminance of the second pixel PX2L1 to the (2*)th apparent luminance BR2*.

Accordingly, the data voltage supplied to the rightmost second pixel PX2R1 may be the largest, whereas the data voltage supplied to the leftmost second pixel PX2L1 is the smallest, and the data voltage supplied to the second pixels PX2L2 and PX2R2 and the first pixel PX1, which are positioned between the second pixels PX2R1 and PX2L1, may gradually increase along the first direction DR1 (e.g., the right side).

According to an embodiment, the second apparent luminance BR2 may be lower than the first apparent luminance BR1 due to the Gaussian distribution characteristics of the relative luminance value graph.

The (2*)th position PO2* may be the farthest position at which the tracked target may be positioned from the display panel PN in the first direction DR1. When the tracked target is positioned outside the (2*)th position PO2*, the tracking camera TRCAM may not track the tracked target, and thus the (2*)th position PO2* is referred to as a threshold position that the tracked target may be positioned. The distance between the tracked target positioned at the (2*)th position PO2* and the first pixel PX1 may be defined as a maximum value that the viewpoint can be spaced apart from the first pixel PX1. Accordingly, the (2*)th apparent luminance BR2* (i.e., apparent luminance at the (2*)th position PO2*) will have a minimum value and, the amount of compensation or the amount of change applied to the data voltage supplied to the leftmost second pixel PX2L1 may be the greatest among the data voltages supplied to the first and second pixels. The first threshold driving mode may be defined as an operating mode of the display device, where the distance between the tracked target and the first pixel PX1 may have a maximum value that the tracked target may be positioned along the first direction DR1.

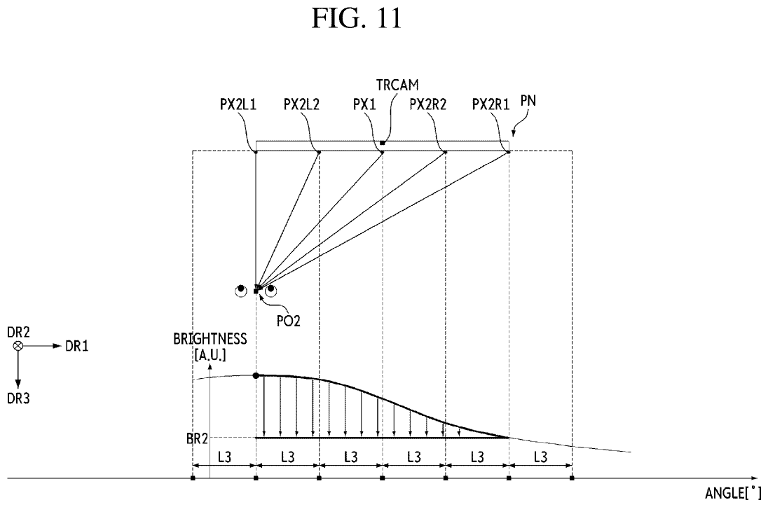

FIG. 11 is a diagram illustrating a display panel operating in a second driving mode according to one embodiment of the present disclosure.

Referring to FIG. 11, the tracked target may be positioned at the second position PO2. The tracking camera TRCAM may detect the tracked target positioned at the second position PO2, thereby enabling the display device to operate in the second driving mode.

A relative luminance value graph, according to a viewing angle observed from the tracked target positioned at the second position PO2, is shown. Since light emitted from the first pixel PX1 and the second pixels PX2L1, PX2L2, PX2R1 and PX2R2 follows the Gaussian distribution, the relative luminance value perceived by the tracked target positioned at the second position PO2 may follow the Gaussian distribution.

In a related art, although all pixels may emit light at the same luminance, luminance perceived by the tracked target positioned at the second position PO2, in accordance with the Gaussian distribution, may be different depending on the position of the pixel. The relative luminance value perceived by the tracked target may be referred to as apparent luminance. Accordingly, the indication that the apparent luminance is substantially equal may mean that the relative luminance value perceived by the tracked target may be equal, but the embodiment of the present disclosure is not limited thereto. In certain cases, the apparent luminance values of light emitted by the plurality of pixels PX1 and PX2 arranged on the display panel PN may be all regarded as the same regardless of the positions of the plurality of pixels PX1 and PX2. For example, when the size of the display panel PN is small, the apparent luminance value difference between the pixels PX1 and PX2 according to the viewing angle is also small, and the apparent luminance perceived by the tracked target may be substantially equal.

The display device is configured to operate in the second driving mode, when a distance between the tracked target and the first pixel PX1 is greater than a distance between the tracked target and the second pixels PX2L1 and PX2L2. In the second driving mode, the distance between the tracked target and the first pixel PX1 may be less than a distance between the tracked target and the second pixels PX2R2 and PX2R1. An angle formed by the tracked target and the second pixel PX2L1 may be 0°, and the tracked target may perceive the highest luminance from the second pixel PX2L1. According to the Gaussian distribution, the luminance perceived by the tracked target positioned at the second position PO2 decreases as the pixel is located farther from the second pixel PX2L1. In other words, the apparent luminance perceived by the tracked target positioned at the second position PO2 decreases as the pixel is located farther from the second pixel PX2L1. Accordingly, the apparent luminance perceived by the tracked target positioned at the second position PO2 may vary depending on the position of the pixel on the display panel PN, thereby causing a problem of non-uniform luminance.

In one embodiment, in order to address the non-uniform luminance, luminance of respective pixels may be reduced to match the smallest luminance value perceived by the tracked target positioned at the second position PO2. For example, since the second pixel PX2R1 is arranged at the rightmost side of the display panel PN in accordance with the Gaussian distribution, the light emitted from the second pixel PX2R1 may be perceived as the lowest luminance by the tracked target positioned at the second position PO2, and the display device may reduce the luminance of the first and second pixels to the lowest luminance accordingly. Specifically, when the luminance of light emitted by the second pixel PX2R1 exhibits a second apparent luminance BR2, the display device operating in the second driving mode may reduce the luminance of the respective pixels to match the apparent luminance of the pixels perceived at the second position PO2 to the second apparent luminance BR2 to improve luminance uniformity.

Since the second pixel PX2L1 positioned at the leftmost side has the highest value of the apparent luminance perceived by the tracked target positioned at the second position PO2, a data voltage supplied to the second pixel PX2L1 may be lowered to reduce the apparent luminance of the second pixel PX2L1 to the second apparent luminance BR2.

Accordingly, the data voltage supplied to the rightmost second pixel PX2R1 may be the largest, whereas the data voltage supplied to the leftmost second pixel PX2L1 is the smallest, and the data voltage, supplied to the second pixels PX2L2 and PX2R2 and the first pixel PX1 which are positioned between the second pixels PX2R1 and PX2L1, may gradually increase along the first direction DR1 (e.g., the right side).

According to an embodiment, the second apparent luminance BR2 may be lower than the first apparent luminance BR1 due to the Gaussian distribution characteristics of the relative luminance value graph.

In addition, the second apparent luminance BR2 may be greater than the (2*)th apparent luminance BR2* because a distance between the second position PO2 and the second pixel PX2L1 is shorter than a distance between the (2*)th position PO2* and the second pixel PX2L1.

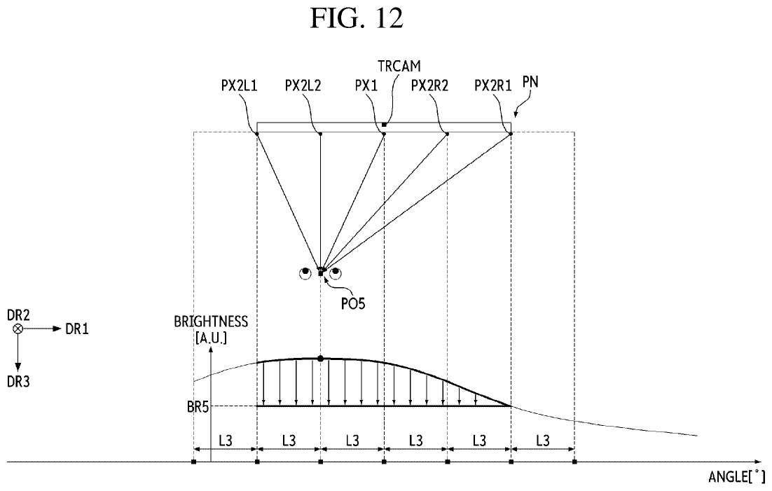

FIG. 12 is a view illustrating a display panel operating in a fifth driving mode according to one embodiment of the present disclosure.

Referring to FIG. 12, the tracked target may be positioned at the fifth position PO5. The tracking camera TRCAM may detect the tracked target positioned at the fifth position PO5, thereby enabling the display device to operate in the fifth driving mode.

A relative luminance value graph, according to a viewing angle, observed from the tracked target positioned at the fifth position PO5, is shown. Since light emitted from the first pixel PX1 and the second pixels PX2L1, PX2L2, PX2R1 and PX2R2 follows the Gaussian distribution, the relative luminance value perceived by the tracked target positioned at the fifth position PO5 may follow the Gaussian distribution.

In a related art, although all pixels may emit light at the same luminance, but luminance perceived by the tracked target positioned at the fifth position PO5, in accordance with the Gaussian distribution, may be different depending on the position of the pixel. The relative luminance value perceived by the tracked target may be referred to as an apparent luminance. Accordingly, the indication that the apparent luminance is substantially equal may mean that the relative luminance value perceived by the tracked target may be substantially equal, but the embodiment of the present disclosure is not limited thereto. In certain cases, the apparent luminance values of light emitted by the plurality of pixels PX1 and PX2 arranged on the display panel PN may be all regarded as the same regardless of the positions of the plurality of pixels PX1 and PX2. For example, when the size of the display panel PN is small, the luminance difference between the pixels PX1 and PX2 according to the viewing angle is also small, and the apparent luminance perceived by the tracked target at respective positions may be substantially equal.

The display device is configured to operate in the fifth driving mode, when a distance between the tracked target and the first pixel PX1 is greater than a distance between the tracked target and the second pixel PX2L2 and substantially the same as a distance between the tracked target and the second pixel PX2L1. In the fifth driving mode, the distance between the tracked target and the first pixel PX1 may be less than a distance between the tracked target and the second pixels PX2R2 and PX2R1. An angle formed by the tracked target and the second pixel PX2L2 may be 0°, and the tracked target may perceive the highest luminance from the second pixel PX2L2. According to the Gaussian distribution, the luminance perceived by the tracked target positioned at the fifth position PO5 decreases as the pixel is located farther from the second pixel PX2L2. In other words, the apparent luminance perceived by the tracked target positioned at the fifth position PO5 decreases as the pixel is located farther from the second pixel PX2L2. Accordingly, the apparent luminance perceived by the tracked target positioned at the fifth position PO5 may vary depending on the position of the pixel on the display panel PN, thereby causing a problem of non-uniform luminance.

In one embodiment, in order to address the non-uniform luminance, luminance of respective pixels may be reduced to match the smallest luminance value perceived by the tracked target positioned at the fifth position PO5. For example, since the second pixel PX2R1 is arranged at the rightmost side of the display panel PN in accordance with the Gaussian distribution, the light emitted from the second pixel PX2R1 may be perceived as the lowest luminance by the tracked target positioned at the fifth position PO5 and the display device may reduce the luminance of the first and second pixels to the lowest luminance accordingly. Specifically, when the luminance of light emitted by the second pixel PX2R1 exhibits fifth apparent luminance BR5, the display device operating in the fifth driving mode may reduce the apparent luminance of the pixels, perceived at the fifth position PO5, to the fifth apparent luminance BR5 to improve luminance uniformity of the display panel.

Since the second pixel PX2L2 has the highest value of the apparent luminance perceived by the tracked target positioned at the fifth position PO5, a data voltage supplied the second pixel PX2L2 may be lowered to reduce the apparent luminance of the second pixel PX2L2 to the fifth apparent luminance BR5.

Accordingly, the data voltage supplied to the rightmost second pixel PX2R1 may be the largest, whereas the data voltage supplied to the second pixel PX2L2 is the smallest, and the data voltage, supplied to the second PX2R2 and the first pixel PX1 which are positioned between the second pixels PX2R1 and PX2L2, may gradually increase along the first direction DR1 (e.g., the right side). Also, since the plurality of pixels are arranged to be spaced apart from each other at the same third distance L3, the data voltage theoretically supplied to the first pixel PX1 will be substantially the same as the data voltage supplied to the leftmost pixel PX2L1.

According to an embodiment, the fifth apparent luminance BR5 may be lower than the first apparent luminance BR1 due to the Gaussian distribution characteristics of the relative luminance value graph.

In addition, the fifth apparent luminance BR5 may be greater than the second apparent luminance BR2.

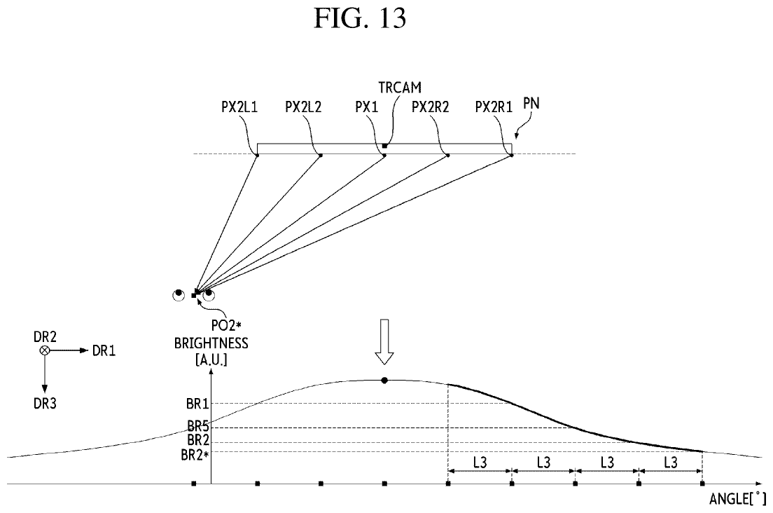

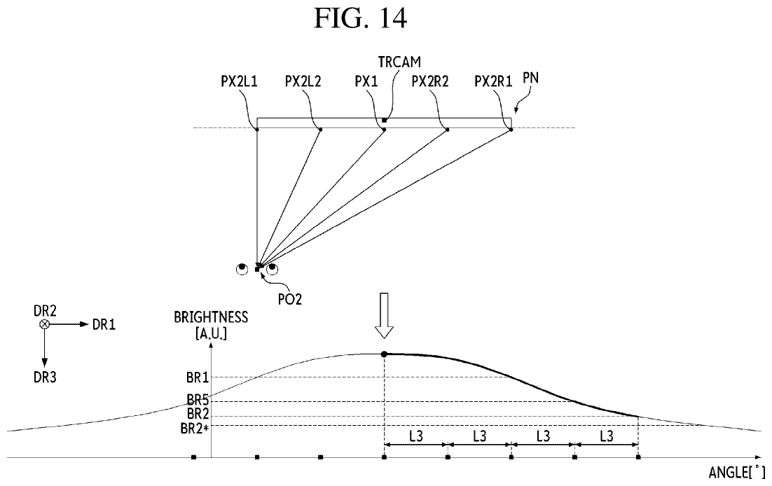

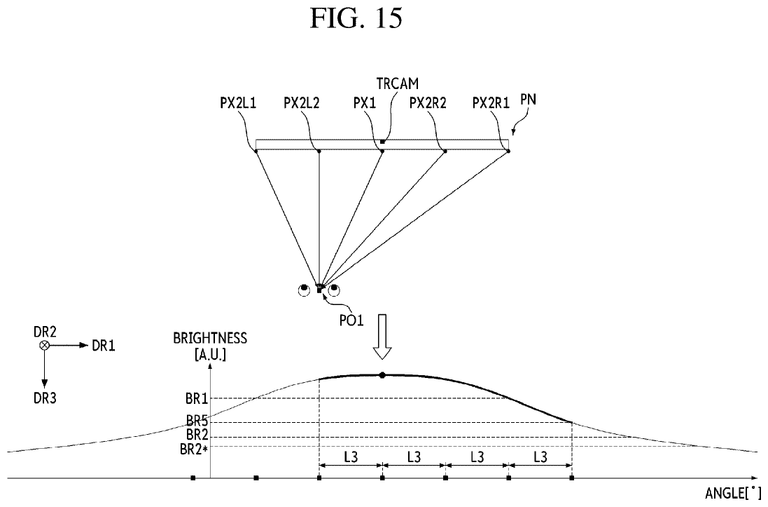

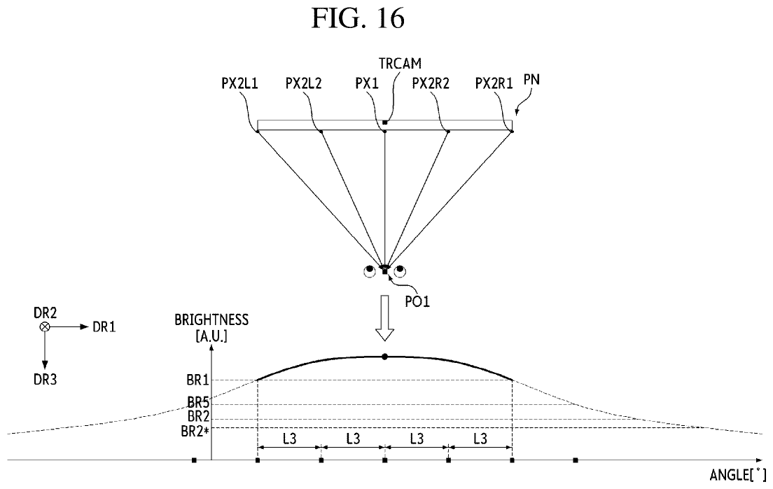

FIGS. 13, 14, 15 and 16 are graphs comparing relative luminance values of the display panel operating in respective driving modes.

Referring to FIGS. 13 to 16, the angular intervals for achieving the apparent luminance at a given tracked target position may be substantially identical in the threshold driving mode, the second driving mode, the fifth driving mode, and the first driving mode. In addition, according to the characteristics of the Gaussian distribution, the apparent luminance observed in the threshold driving mode will be the smallest, which corresponds to the (2*)th apparent luminance BR2*, and the apparent luminance observed in the first driving mode will be the largest which corresponds to the first apparent luminance BR1.

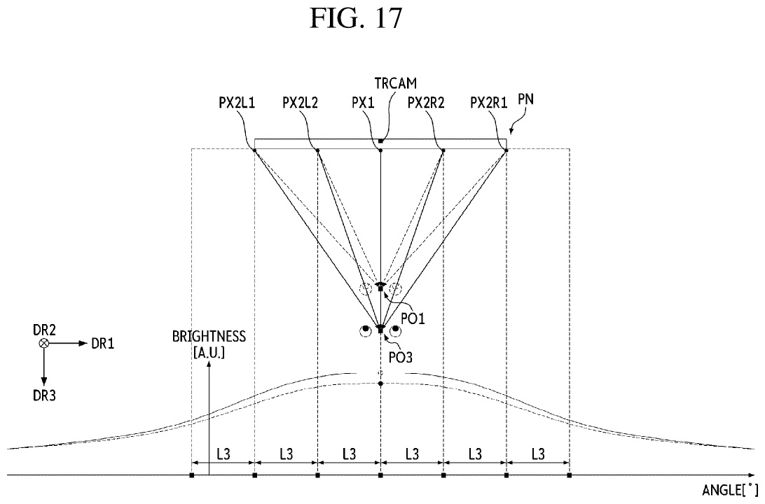

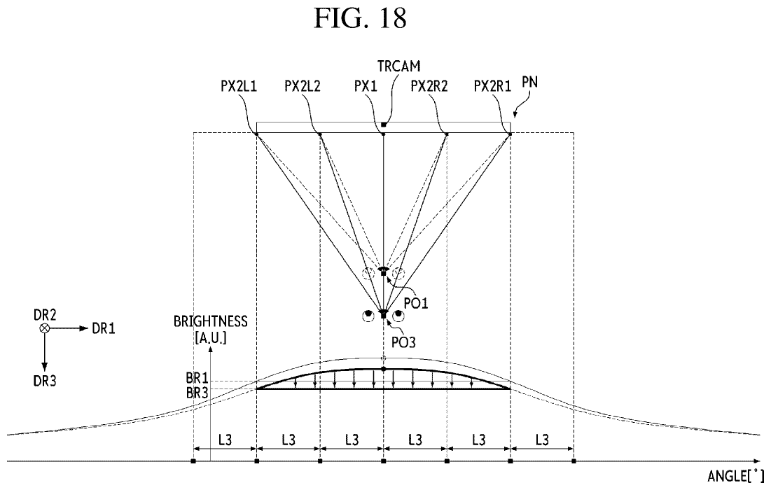

FIGS. 17 and 18 are views illustrating a display panel operating in a third driving mode according to one embodiment of the present disclosure.

Referring to FIG. 17, the third position PO3 and the first position PO1 are arranged on a virtual straight line extending along the third direction DR3 from the central portion of the display panel PN, but their respective distances from the display panel PN may be different from each other. The third position PO3 may have a relatively greater distance from the display panel PN than the first position PO1.

When the position of the tracked target moves in a vertical direction (the third direction DR3), a peak value of a Gaussian graph may decrease.

Referring to FIG. 18, apparent luminance perceived by the tracked target arranged at the third position PO3 may be the third apparent luminance BR3. For providing the third apparent luminance BR3 to the tracked target positioned at the third position PO3, the data voltage supplied to the first pixel PX1 that provides the third apparent luminance BR3 may be less than the data voltage supplied to the second pixels PX2L1, PX2L2, PX2R2 and PX2R1.

The amount of change or compensation applied to the data voltage supplied to the first pixel PX1 may be the greatest, and the amount of change of the data voltage supplied to the second pixel may gradually decrease toward the second pixel arranged to the left or right.

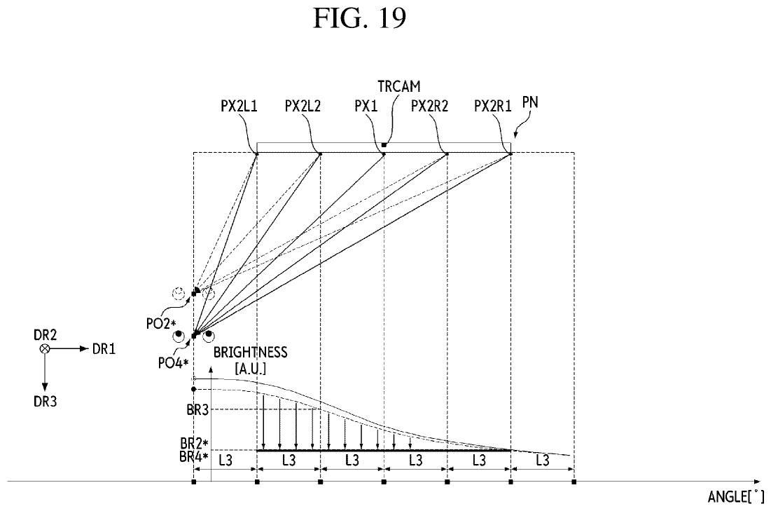

FIG. 19 is a view illustrating a display panel operating in a second threshold driving mode according to one embodiment of the present disclosure.

Referring to FIG. 19, a tracked target positioned at a (4*)th position PO4* in accordance with the modified Gaussian graph may perceive a pixel arranged on the display panel PN with (4*)th apparent luminance BR4*. The (4*)th apparent luminance BR4* may be lower than the (2*)th apparent luminance BR2*. In addition, a distance between the tracked target arranged at the (4*)th position PO4* and the first pixel PX1 may be greater than a distance between the tracked target arranged at the (2*)th position PO2* and the first pixel PX1.

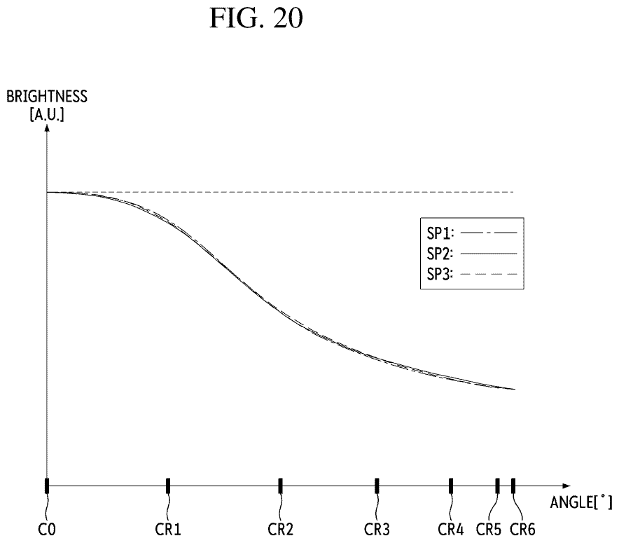

FIG. 20 is a graph comparing relative luminance values of light emitted from a subpixel according to one embodiment of the present disclosure.

Referring to FIG. 20, a method for adjusting the luminance of a pixel is provided. Since the pixel includes a first subpixel SP1, a second subpixel SP2, and a third subpixel SP3, luminance of the pixel may be obtained by summing the luminance values of the respective subpixels. According to one embodiment, luminance of the pixel may be adjusted by lowering a data voltage supplied to each of the plurality of subpixels SP1, SP2 and SP3, which exhibit a luminance difference at the same viewing angle.

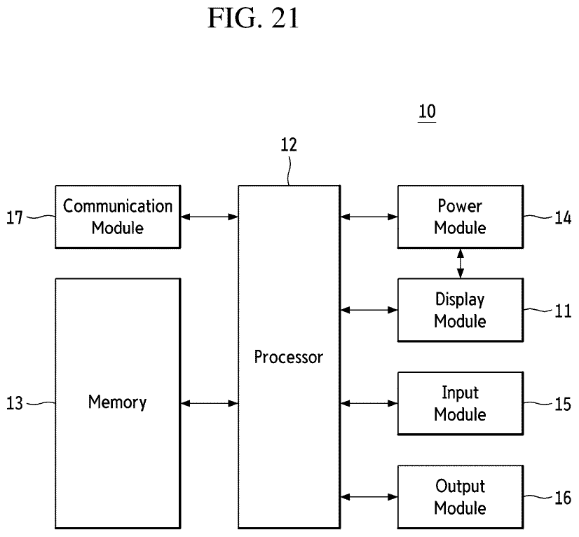

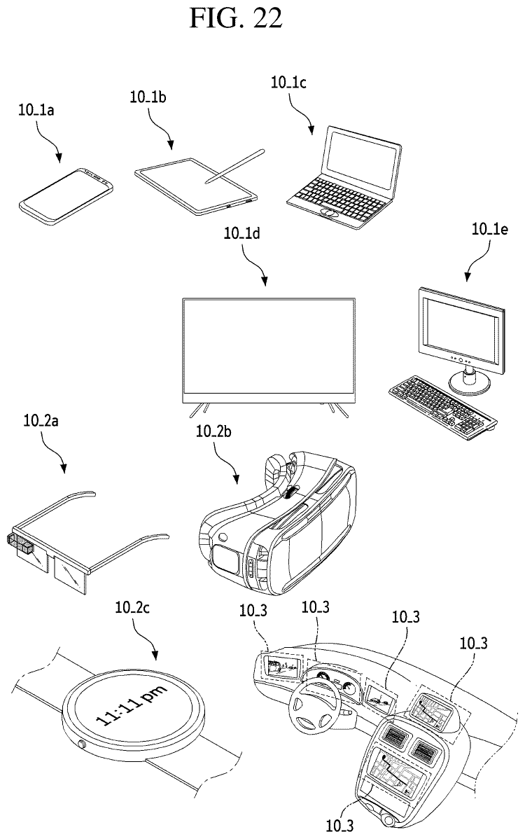

FIG. 21 is a block diagram illustrating an electronic device according to one embodiment. FIG. 22 illustrates schematic diagrams of electronic devices according to various embodiments.

Referring to FIG. 21, an electronic device 10 according to one embodiment may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

Data information required for an operation of the processor 12 or the display module 11 may be stored in the memory 13. When the processor 12 executes an application stored in the memory 13, an image data signal and/or an input control signal is transmitted to the display module 11, and the display module 11 may process the received signal and output corresponding image information through a display screen.

The power module 14 may include a power supply module such as a power adapter or a battery device. The power module 14 may include a power conversion module. The power conversion module may convert a power source supplied by the power supply module to generate a power voltage used for the operation of the electronic device 10.

At least one of the respective components of the above-described electronic device 10 may be included in the display device according to the above-described embodiments. In addition, some of the individual modules functionally included in one module may be incorporated into the display device, while others may be provided separately from the display device. For example, the display device includes the display module 11, whereas the processor 12, the memory 13 and the power module 14 may be provided as separate devices within the electronic device, apart from the display device.

Referring to FIG. 22, various electronic devices 2 to which the display devices according to the embodiments of the present disclosure are applied may include electronic devices for image display, such as a smart phone 10_1a, a tablet PC 10_1b, a laptop 10_1c, a TV 10_1d, and a desk monitor 10_1e. In addition, the various electronic devices 2 to which the display devices according to the embodiments of the present disclosure are applied may include wearable electronic devices including display modules, such as smart glasses 10_2a, a head mounted display 10_2b, and a smart watch 10_2c, and a vehicle electronic device 10_3 including display modules, such as a vehicle dashboard, a center fascia, a center information display (CID) arranged on the dashboard, and a room mirror display.

Although embodiments of the disclosure have been described above with reference to the accompanying drawings, it will be understood by those having ordinary skill in the technical field to which the disclosure pertains that the disclosure may be practiced in various other specific forms without altering the technical concept or essential features of the disclosure. Accordingly, the embodiments described above are to be considered exemplary in all respects and are not intended to be limiting.

What is claimed is:

1. A display device comprising:
a tracking camera configured to track a position of a tracked target; and
a display panel including:
a first pixel positioned at a first pixel position of the display panel, and configured to exhibit a first luminance in a first driving mode and to exhibit a third luminance in a second driving mode; and
a second pixel positioned at a second pixel position spaced apart from the first pixel position in a first direction, and configured to exhibit a second luminance in the first driving mode and to exhibit a fourth luminance in the second driving mode,
wherein the display device is configured to adjust the first luminance and the second luminance such that a first apparent luminance and a second apparent luminance, which are respective luminance levels, originating from the first and second pixels, at a first location of the tracked target, are substantially equal in the first driving mode, and to adjust the third luminance and the fourth luminance such that a third apparent luminance and a fourth apparent luminance, which are respective luminance levels, originating from the first and second pixels, at a second location of the tracked target, are substantially equal in the second driving mode, where the first driving mode and the second driving mode are determined based on the first and second locations of the tracked target, and the first apparent luminance is different from the third apparent luminance.

2. The display device of claim 1, wherein the display device is configured to adjust first and second data voltages supplied to the respective first and second pixels such that the first apparent luminance and the second apparent luminance are substantially equal in the first driving mode, and to adjust third and fourth data voltages supplied to the respective first and second pixels such that the third apparent luminance and the fourth apparent luminance are substantially equal in the second driving mode.

3. The display device of claim 1, wherein a distance between the tracked target and the first pixel in the first driving mode is less than a distance between the tracked target and the first pixel in the second driving mode, and a distance between the tracked target and the second pixel in the first driving mode is greater than a distance between the tracked target and the second pixel in the second driving mode.

4. The display device of claim 3, wherein, the display device is configured to operate in the first driving mode when the distance between the tracked target and the first pixel is less than the distance between the tracked target and the second pixel, and to operate in the second driving mode when the distance between the tracked target and the first pixel is greater than the distance between the tracked target and the second pixel.

5. The display device of claim 3, wherein the third apparent luminance is lower than the first apparent luminance.

6. The display device of claim 1, wherein, the display device is configured to operate either in the first driving mode or in the second driving mode, when the tracking camera has detected the tracked target positioned within a virtual plane that are spaced apart from and overlaps with a surface plane of the display panel in a vertical direction.

7. The display device of claim 1, wherein the first pixel is configured to exhibit a fifth luminance and the second pixel is configured to exhibit a sixth luminance in a third driving mode, and the display device is configured to adjust the fifth luminance and the sixth luminance such that a fifth apparent luminance and a sixth apparent luminance, which are respective luminance levels, originating from the first and second pixels, at a third location of the tracked target, are substantially equal in the third driving mode, the fifth apparent luminance is different from the first apparent luminance, and a distance between the tracked target and a surface plane of the display panel in a vertical direction in the first driving mode is less than a distance between the tracked target and the surface plane of the display panel in the vertical direction in the third driving mode.

8. The display device of claim 7, wherein a distance between the tracked target and the surface plane of the display panel in the first driving mode is substantially equal to a distance between the tracked target and the surface plane of the display panel in the second driving mode.

9. The display device of claim 7, wherein a distance between the tracked target and the surface plane of the display panel in the first driving mode is less than a distance between the tracked target and the second pixel in the third driving mode.

10. The display device of claim 7, wherein, in the third driving mode, a distance between the tracked target and the first pixel is less than a distance between the tracked target and the second pixel.

11. The display device of claim 7, wherein the first pixel is configured to exhibit a seventh luminance and the second pixel is configured to exhibit an eighth luminance in a fourth driving mode, and the display device is configured to adjust the seventh luminance and the eighth luminance such that a seventh apparent luminance and an eighth apparent luminance, which are respective luminance levels, originating from the first and second pixels, at a fourth location of the tracked target, are substantially equal in the fourth driving mode, the seventh apparent luminance is different from the first apparent luminance and the fifth apparent luminance, respectively, and the distance between the tracked target and the surface plane of the display panel in the third driving mode is substantially equal to a distance between the tracked target and the surface plane of the display panel in the fourth driving mode.

12. The display device of claim 11, wherein a distance between the tracked target and the first pixel in the third driving mode is less than a distance between the tracked target and the first pixel in the fourth driving mode, and a distance between the tracked target and the second pixel in the third driving mode is greater than a distance between the tracked target and the second pixel in the fourth driving mode.

13. The display device of claim 11, wherein a distance between the tracked target and the first pixel in the second driving mode is less than a distance between the tracked target and the first pixel in the fourth driving mode, and a distance between the tracked target and the second pixel in the second driving mode is less than a distance between tracked target and the second pixel in the fourth driving mode.

14. An electronic device comprising:
a processor configured to provide an image signal;
a display module configured to receive the image signal from the processor, and to display an image based on the image signal; and
a power module supplying a power voltage to the display module,
wherein the display module includes:
a tracking camera configured to track a tracked target; and
a display panel including:
a first pixel arranged at a first pixel position of the display panel, and configured to exhibit a first luminance in a first driving mode and to exhibit a third luminance in a second driving mode; and
a second pixel positioned at a second pixel position spaced apart from the first pixel position in a first direction, and configured to exhibit a second luminance in the first driving mode and to exhibit a fourth luminance in the second driving mode,
wherein the electronic device is configured to adjust the first luminance and the second luminance such that a first apparent luminance and a second apparent luminance, which are respective luminance levels, originating from the first and second pixels, at a first location of the tracked target, are substantially equal in the first driving mode, and to adjust the third luminance and the fourth luminance such that a third apparent luminance and a fourth apparent luminance, which are respective luminance levels, originating from the first and second pixels, at a second location of the tracked target, are substantially equal in the second driving mode, and the first apparent luminance is different from the third apparent luminance.

15. The electronic device of claim 14, wherein the electronic device is configured to adjust first and second data voltages supplied to the respective first and second pixels such that the first apparent luminance and the second apparent luminance are substantially equal in the first driving mode, and to adjust third and fourth data voltages supplied to the respective first and second pixels such that the third apparent luminance and the fourth apparent luminance are substantially equal in the second driving mode.

16. The electronic device of claim 14, wherein the first pixel is configured to exhibit a fifth luminance and the second pixel is configured to exhibit a sixth luminance in a third driving mode, and the electronic device is configured to adjust the fifth luminance and the sixth luminance such that a fifth apparent luminance and a sixth apparent luminance, which are respective luminance levels, originating from the first and second pixels, at a third location of the tracked target, are substantially equal in the third driving mode, the fifth apparent luminance is different from the first apparent luminance, and a distance between the tracked target and a surface plane of the display panel in a vertical direction in the first driving mode is less than a distance between the tracked target and the surface plane of the display panel in the vertical direction in the third driving mode.

17. The electronic device of claim 16, wherein the first pixel is configured to exhibit a seventh apparent luminance and the second pixel is configured to exhibit an eighth luminance in a fourth driving mode, and the electronic device is configured to adjust the seventh luminance and the eighth luminance such that a seventh apparent luminance and an eighth apparent luminance, which are respective luminance levels, originating from the first and second pixels at a fourth location of the tracked target, are substantially equal in the fourth driving mode, the seventh apparent luminance is different from either the first apparent luminance or the fifth apparent luminance, and the distance between the tracked target and the surface plane of the display panel in the third driving mode is substantially equal to a distance between the tracked target and the surface plane of the display panel in the fourth driving mode.

18. The electronic device of claim 17, wherein a distance between the tracked target and the first pixel in the first driving mode is less than a distance between the tracked target and the first pixel in the third driving mode, and a distance between the tracked target and the first pixel in the second driving mode is less than a distance between the tracked target and the first pixel in the fourth driving mode.

19. The electronic device of claim 17, wherein a distance between the tracked target and the second pixel in the first driving mode is less than a distance between the tracked target and the second pixel in the third driving mode, and a distance between the tracked target and the second pixel in the second driving mode is less than a distance between tracked target and the second pixel in the fourth driving mode.

20. A method for operating a display device comprising:
tracking a position of a tracked target by a tracking camera; and
adjusting a first luminance of a first pixel and a second luminance of a second pixel, respectively, such that a first apparent luminance and a second apparent luminance, which are respective luminance levels, originating from the first and second pixels, at a first location of the tracked target, are substantially equal in a first driving mode, and adjusting a third luminance of the first pixel and a fourth luminance of the second pixel such that a third apparent luminance and a fourth apparent luminance, which are respective luminance levels, originating from the first and second pixels, at a second location of the tracked target, are substantially equal in a second driving mode,
wherein the first apparent luminance and the second apparent luminance are adjusted to be substantially equal in the first driving mode by adjusting first and second data voltages supplied to the respective first and second pixels, and the third apparent luminance and the fourth apparent luminance are adjusted to be substantially equal in the second driving mode by adjusting third and fourth data voltages supplied to the respective first and second pixels,
wherein the first driving mode and the second driving mode are determined based on the first and second locations of the tracked target, and the first apparent luminance is different from the third apparent luminance.
